(19) United States
(12) Patent Application Publication
(10) Pub. No.: US 2016/0117371 A1
(43) Pub. Date: Apr. 28, 2016

(54) JOB AUTHORING WITH DATA PREVIEW

(71) Applicant: Microsoft Corporation, Redmond, WA (US)

(72) Inventors: Cheryl Couris, Seattle, WA (US); Christina Storm, Seattle, WA (US); Andrew J. Peacock, Seattle, WA (US); Amir Netz, Bellevue, WA (US); Chiu Ying Cheung, Redmond, WA (US); Michael J. Flasko, Kirkland, WA (US); Kevin Grealish, Seattle, WA (US); Giovanni M. Della-Libera, Redmond, WA (US); Sonia P. Carlson, Redmond, WA (US); Mark W. Heninger, Preston, WA (US); Paula M. Bach, Redmond, WA (US); Taurean A. Jones, Issaquah, WA (US)

(21) Appl. No.: 14/521,465

(22) Filed: Oct. 23, 2014

(51) Int. Cl. G06F 17/30

(52) U.S. Cl. CPC G06F 17/30563; G06F 17/30589; G06F 17/30383

(57) ABSTRACT

Jobs can be authored in conjunction with a visual workspace. Upon selection of representation of a data source in the workspace, a preview of the data source can be generated within context of the visual workspace. Further, representations of one or more data transformation operations can be provided with the preview. Selection of a transformation operation results in an updated preview reflecting application of the operation as well as generation of backend code to perform the operation. Furthermore, a job comprising one or more transformation operations can be added to the workspace automatically.

### BACKGROUND

Processing of vast quantities of data, or so-called big data, to glean valuable insight involves first transforming data. Data is transformed into a useable form for publication or consumption by business intelligence endpoints, such as a dashboard, by creating, scheduling, and executing of one or more jobs. In this context, a job is a unit of work over a data comprising one or more transformation operations. Typically, jobs are manually coded by data developers, data architects, business intelligence architects, or the like.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to a job authoring with data preview. An interactive visual workspace for diagramming workflows comprising one or more jobs, such as those regarding data transformation, is provided. Upon selection of a data source within the workspace, a preview of the data source can be displayed within context of the workspace. Further, visual representations of one or more transformation operations can be provided in connection with the preview to enable graphical specification of transformation operations. After a transformation operation is selected, the preview can be updated to reflect the operation and backend code generated that implements the operation. A view can also be provided of the backend code allowing an option for addition or modification of operations. Once operation specification is complete, transformation operations can be committed. Subsequently, a representation of a job comprising one or more transformation operations can be added to the workspace automatically.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a visual authoring system.

FIG. 2 is a block diagram of a representative job-authoring component.

FIG. 3 is a block diagram of a representative preview component.

FIG. 4 is a screenshot of an exemplary visual authoring interface.

FIG. 5 is a screenshot of an exemplary visual authoring interface including a preview panel.

FIG. 6 is a screenshot of an exemplary visual authoring interface including a preview with graph representations of data.

FIG. 7 is a screenshot of an exemplary visual authoring interface including a preview with graphs inserted for each column of data.

FIG. 8 is a screenshot of an exemplary visual authoring interface including operation parameterization with a representation of data presented in a preview.

FIG. 9 is a screenshot of an exemplary visual authoring interface including an updated preview panel.

FIG. 10 is a screenshot of an exemplary visual authoring interface illustrating addition of a newly created job to a workspace.

FIG. 11 is a screenshot of an exemplary visual authoring interface including a code view.

FIG. 12 is a flow chart diagram of a method of assisting a user in authoring a job.

FIG. 13 is a flow chart diagram of a method of generating a data preview.

FIG. 14 is a flow chart diagram a visualization method for job authoring.

FIG. 15 is a flow chart diagram of a method of injecting a visualization into a preview.

FIG. 16 is a schematic block diagram illustrating a suitable operating environment for aspects of the subject disclosure.

### DETAILED DESCRIPTION

Details below generally pertain to a job authoring with data preview. An interface is provided that includes an interactive visual workspace for diagrammatic authoring of workflows comprising one or more jobs, such as those relating to data transformation. The workspace can include a visual representation of a data source, for example dragged and dropped from a source pane. Upon selection of the data source, a preview can be generated and presented to a user within the context of the workspace. The preview can include at least a subset of data from the data source and optionally one or more graphs associated with the data. This in-situ preview can expedite the authoring process at least because data can be inspected without requiring a break in context. Additionally, visual representations of one or more transformation operations can be provided in connection with the preview to enable graphical specification of transformations. Selection of a transformation operation results in the preview being updated to reflect application of the operation. In this way, a user is assisted progressively in selecting transformation operations to achieve a desired result. Selection of a transformation operation can also trigger generation of backend code that implements the operation. Further, a code view can be presented to allow code to be viewed as well as modified. Once a user is finished specifying transformations graphically and/or manually, the operations can be committed. Subsequently, a representation of a job comprising one or more transformation operations can be added to the visual workspace automatically.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

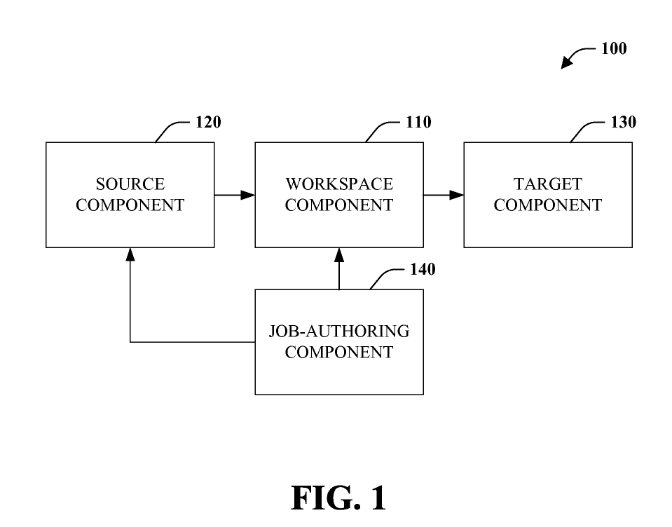

Referring initially to FIG. 1, a visual authoring system 100 is illustrated. The visual authoring system 100 includes workspace component 110, source component 120, target component 130, and job-authoring component 140. The workspace component 110 is configured to enable diagrammatic authoring of jobs (e.g., series of one or more activities or steps that modify data) and job pipelines (e.g., input dataset, job, and output dataset), by providing an interactive visual workspace or canvas. For example, data sources, or in other words, datasets, can be represented as cylinders and connected by arrows to jobs that produce modified data sources. Essentially, a user can draw a diagram of relationships between data sources and jobs. This results in a very intuitive experience that saves time with respect to understanding relationships and ultimately specifying jobs.

The source component 120 is configured to produce a visual representation of available data sources for job authoring. Arbitrary data sources can be acquired and made available by the source component 120 including on-premises data sources and cloud-based data sources of substantially any format (e.g., table, file, stream . . . ) or structure (e.g., structured, unstructured, semi-structured). In other words, the source component 120 is configured to expose heterogeneous data sources. Data sources can made available by search and import functionality provided by the source component 120. Additionally, the source component 120 can be configured to monitor user or entity accounts or the like and make accessible data sources available automatically. Data sources rendered by the source component 120 are interactive and can be used as input for one or more jobs. For example with a gesture, such as drag-and-drop, a data source from a source area can be added to a workspace.

The target component 130 is configured to provide visual location to display final data sources or datasets after all transformations have been applied. These data sources can subsequently be published or consumed by an application, such as an analytics application. A result of a job, or series of jobs, can be dragged from the workspace and dropped in a target visualization area.

The job-authoring component 140 is configured to enable visual authoring of jobs comprising one or more transformation operations. In particular, the authoring component 140 can interact with at least the source component 120 and the workspace component 110 to facilitate job construction in conjunction with a diagram in a workspace from available data sources.

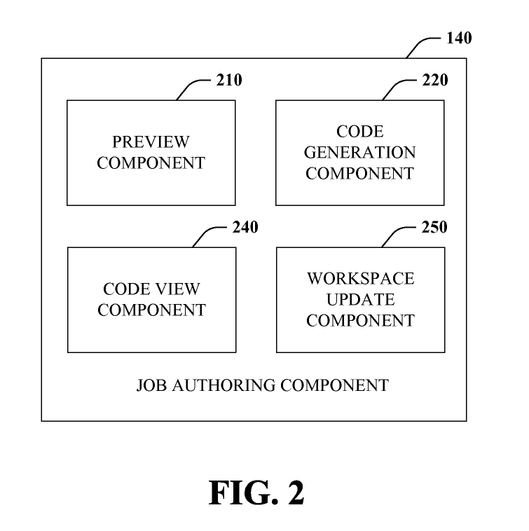

FIG. 2 depicts a representative job-authoring component 140 in further detail. As shown, the job-authoring component 140 includes preview component 210. The preview component 210 is configured to generate a preview portion of an interface, such as a window panel or pane, which among other things provides a data preview. In particular, upon selection of a data source in the workspace by some gesture or other indication (e.g., touch, click, point, hover, voice command . . . ), a data preview interface portion can be presented in conjunction with a workspace. In other words, the data preview portion is presented within the context of the workspace or in-situ as opposed to outside the context of the workspace in a different window or interface, for example. Although not limited thereto, in accordance with one embodiment the preview portion can be displayed upon a single gesture, such as one click, or multiple gestures. In addition to providing a visualization based on at least a subset of data source data, the preview component 210 further provides functionality and visualizations that enable selection of one or more transformation operations over the data source. This enables quick sandboxing and experimenting by way of a testing environment without having to build full pipelines comprising a plurality of transformation jobs.

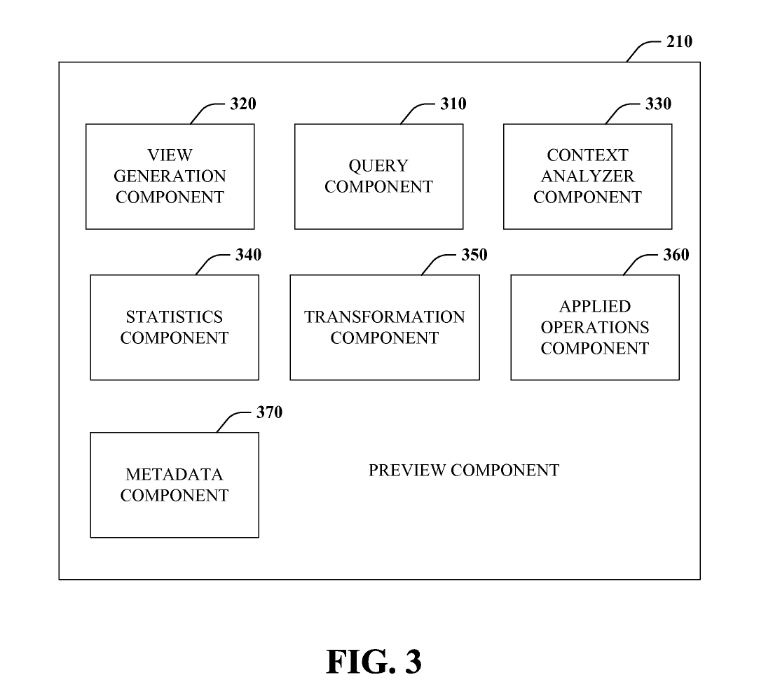

Turning briefly to FIG. 3, a representative preview component 210 is illustrated in further detail. In particular, the preview component 210 includes query component 310. The query component 310 is configured to generate a query, initiate query execution, and receive results. The generated query is specified over the selected data source and returns at least a subset of data from the data source. For example, a query can be generated that returns the first hundred rows of data from a tabular source. Of course, the query is not limited to tabular sources but rather can apply to substantially any data source. Additionally, the number of rows could vary or a different approach could be taken like returning a number of columns, returning a random or pseudorandom sample of the data, or a number of segments or clusters of data such as a first segment, a middle segment, and an end segment.

View generation component 320 generates a view of the data acquired by the query component 310. In accordance with one aspect, the view generation component 320 can simply present the data in some form, such as a tabular form comprising rows and columns. Additionally or alternatively, the view generation component 320 can generate a different view or visualization of data. By way of example, the view generation component 320 can be configured to generate graphs based on the data, such as a pie graph, a bar group, a line graph, or a histogram. Further, the view generation component 320 can generate a view based on the data. For example, if the data includes latitude and longitude, the view generation component 320 can generate a map. As another example, if the data includes time, a timeline representation can be generated. The view selected can be based on data but also on user selection as well as settings/preferences, among other things.

Context analyzer component 330 is configured to analyze available context information and provided a suggestion to the query component 310 to enable generation of a useful query and resulting preview. In accordance with one embodiment, the query component 310 can default to producing a limited number of rows of data, for example. However, this may not be optimal. Consider for example a set of data sorted alphabetically. Generating a default number of results may correspond to data starting solely with the letter “A” and may not be representative of the data as a whole. If this issue can be determined or inferred, for example based on data source metadata or previously interactions with data, among other things, the context analyzer component 330 can direct or suggest that the query component 310 to generate a query that acquires more data, a random or pseudorandom sampling of data or a split of data into segments (e.g. top, middle bottom). Similarly, if the context analyzer component 330 is able to determine or infer that data will or is likely to be presented graphically based on the data, settings or preferences, or historical interaction, generating a random or pseudorandom sampling can be suggested.

Statistics component 340 is configured to determine a set of descriptive statistics regarding an entire data set or portions thereof. For example, the statistics component 340 is configured to compute measures such as counts (e.g., count of all rows, unique value count, missing value count), ranges (e.g., minimum, maximum, range), and statistical summaries (e.g., mean, median, mode, variance, standard deviation . . . ), among others. These measures can be provided to the view generation component 320, which can visualize these measures and a variety of ways. This provides users with a quick overview of the data with which they are working. For example, relevant statics can be presented for each column of data within the data preview. For instance, a graph of distinct products in a product column can be presented to give a user insight regarding distribution of the data in the column. As other example, the measures can be utilized to produce graphs capturing sales over time and different type of products. Further, the statistics component 340 include or employ an external component to apply machine learning techniques with respect to data to determine the most relevant data to present to a user and in what form (e.g., bar graph, pie chart, text . . . ).

Transformation component 350 is configured to present selectable visual representations of one or more transformations operators such as but not limited to sort, group, split, and pivot. If necessary, the transformation operations can be parameterized directly by manually entering the parameters in a popup box, for instance, or indirectly specifying the parameters with respect to a data in a preview. For example, a “group by” operation requires specification of a parameter such as a column name. That column name could be specified directly or selected within preview data. Further, the representations of the one or more transformation operations can be presented in conjunction or in context with preview data or a visualization based thereon, for example in a menu or ribbon. After a transformation operation is identified by selecting a corresponding visual representation (e.g., touch, click . . . ), the transformation component 350 can initiate generation of a new query by the query component 310 that reflects application of the selected operation. As a result, an updated data preview will be presented that shows how data is affected by application of a selected operation. Multiple operations can be selected resulting in updated previews. In this way, a user is assisted progressively in selecting transformation operations to achieve a desired result.

Applied operations component 360 is configured to track and display selected transformations operations. Each operation that is selected recorded. A sequence of transformation operations can subsequently be presented visually. As a result, users are informed of the operations that have been selected. In accordance with one aspect, the transformation operators are selectable and allow a user to remove operations or reorder operations, among other things.

Metadata component 370 is configured to acquire metadata regarding a data source and display the metadata. For example, the metadata could include the number of columns and column names with respect a tabular view. Furthermore, the metadata component 370 can be configured to indicate differences between the data provided or used in the data preview and the entire data source. For example, the metadata component can display the number of columns or rows displayed versus the total number of columns or rows of a data source. Still further, the metadata component 370 can provide a text box or the like to accept metadata from a user associated with a transformed output. This metadata can subsequently be of use with respect to at least searches for data.

Returning to FIG. 2, the job-authoring component 140 also include code generation component 220. The code generation component can generate backend code, for example in a scripting programming language (e.g., M-Script), that implements selected transformation operations. In accordance with one embodiment, the code generation component 220 can progressively modify the code upon selection of transformation operations such that the backend code is up to date. Of course, code generation could be deferred until a user is finished specifying transformations.

Code view component 240 is configured to present a view of the code that implements transformation operations. The code view component 240 also allows a user to directly add, delete, or modify code that implements transformations. Accordingly, the code view can be embodied as a code editor. In accordance with one embodiment, changes made directly to the code can also be reflected with respect to a preview. For example, upon manually authoring a transformation, the preview component 210 can present a preview that includes the transformation. Similarly, code generated based on graphical specification of transformations operations can be available within the code view. Consequently, users can author transformation code directly by way of the code view or indirectly by way of a graphical interface. Further, users can switch between the two authoring environments.

Workspace update component 250 is configured to update the workspace based on transformation operations associated with a data source. Upon an indication that that authoring is complete and a set of transformation operations are to be saved or committed, the workspace can be updated. More specifically, a representation of a job comprising one or more specified transformation operations can be automatically added to the workspace. Further, the data source over which the transformation operations are to be executed is visually linked to the job representation. Additionally, a representation of the transformed output can be linked to the representation of a job. As a result, a diagram is displayed of a job receiving input from a data source and outputting a new data source that reflects application of one or more transformation operations provided by the job.

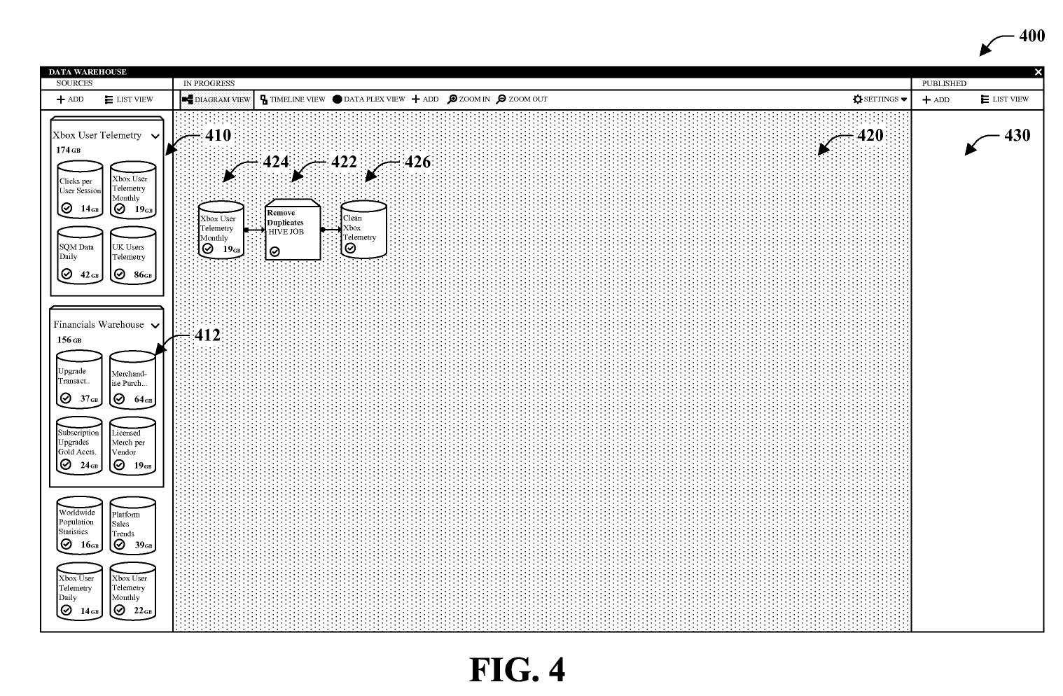

FIGS. 4-11 are exemplary screenshots illustrating various visualization aspects associated with the visual authoring system 100. These screenshots are intended to aid clarity and understanding with respect to aspects of this disclosure and are not intended to limit the claimed subject matter thereto. It is to be appreciated that the provided screenshots depict solely one implementation. Various other combinations and arrangements of graphical elements and text are contemplated and intended to fall within the scope of the appended claims.

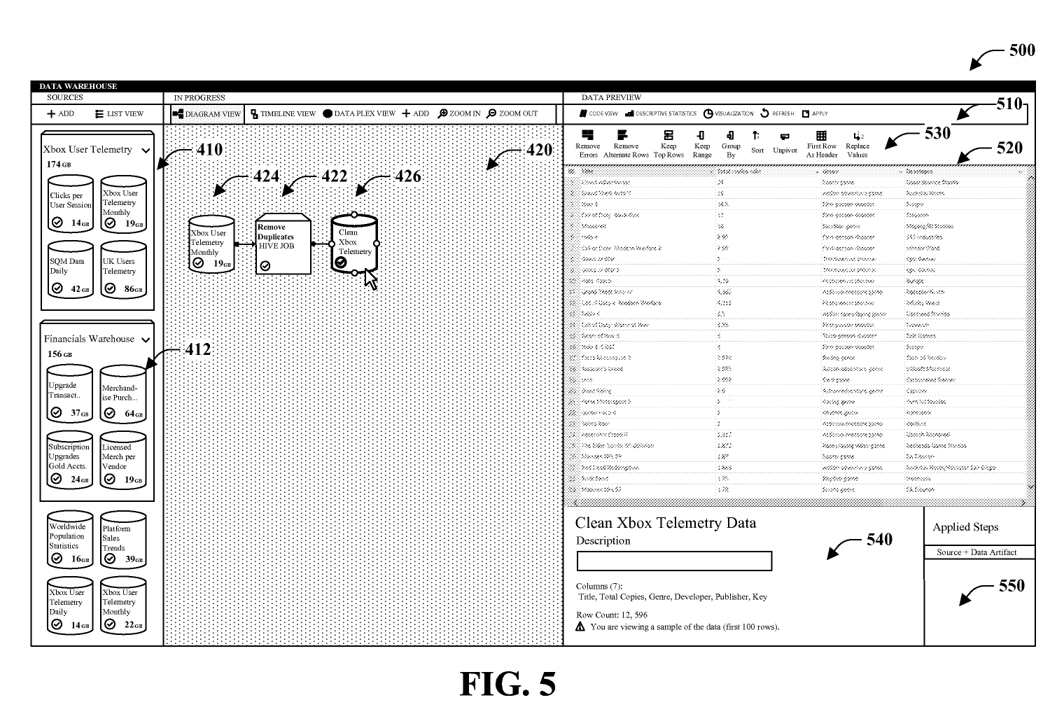

FIG. 4 is a screenshot of a visual authoring interface 400 that can be produced by the visual authoring system 100. As shown, the interface includes three panels, source panel 410, workspace panel 420, and published panel 430. The source panel 410 presents a plurality of available data sources 412 and enables sources to be added or deleted therefrom. It should be appreciated that the data sources 412 depicted in source panel 410 can be arbitrary data sources. For example, some data sources 412 can be associated with on-premises data while other data sources are associated with network or cloud data stores. Furthermore, the data sources 412 can be of substantially any structure or format. The workspace panel 420 provides an interactive diagrammatic view of data sources and jobs. As shown, a job such as one that removes duplicates is represented as a first cube 422. The first cube 422 is connected to a source represented as a first cylinder 424. In accordance with one implementation, the source representation could have been dragged and dropped from the source panel 410. A line with an arrow connects the first cylinder 424 to the cube indicating flow of data from left to right from a source to a job. Additionally, output of the job is represented as a second cylinder 426 and connected with a line and arrow from the first cube 422 to the second cylinder 426 depicting that the second cylinder represents the output of a job. The published pane 430 provides visual representation of published or consumable data sources after all desired transformations are performed. Upon selection of the second cylinder 426 in the workspace panel 420, the screenshot of FIG. 5 can result.

FIG. 5 is a screenshot of a visual authoring interface 500 that can be produced by the visual authoring system 100. Visual authoring interface 500 is similar to visual authoring interface 400 in that it includes the source panel 410 and the workspace panel 420, as previously described. Here, the source represented by the second cylinder 426 is highlighted to indicate selection, for example by positioning a pointer over the second cylinder 426 and clicking. Selection of a data source results in presentation of preview panel 510 alongside the workspace panel 420. In a first portion 520 of the preview panel 510, at least a subset of data, here, in a tabular form is presented. This provides a user with a general idea of the data included in the selected data source as well as the effect of changes. Second portion 530 of the preview panel 510 is a toolbar or ribbon including graphical representations of a set of transformation operations. Upon selection, code for the transformation operation can be automatically generated and the first portion 520 can be updated to reflect application of the operation. Third portion 530 of the preview panel 510 displays metadata regarding the source. For example, the name of a data source can be presented as well as the number of rows and columns comprising the data source. Additionally, differences between the data provided in the first portion 520 and the entire data source can be displayed. For example, an indication can be provided noting that the data preview is showing one hundred rows of twelve thousand total or seven of one hundred columns. Furthermore, a user may enter additional metadata such as a description in a text box. Fourth portion 540 of the preview panel 510 presents visual representations of transformation operations that can be applied. Such transformation operations can include removing errors, removing alternate rows, grouping sorting, pivoting, and replacing values, among others.

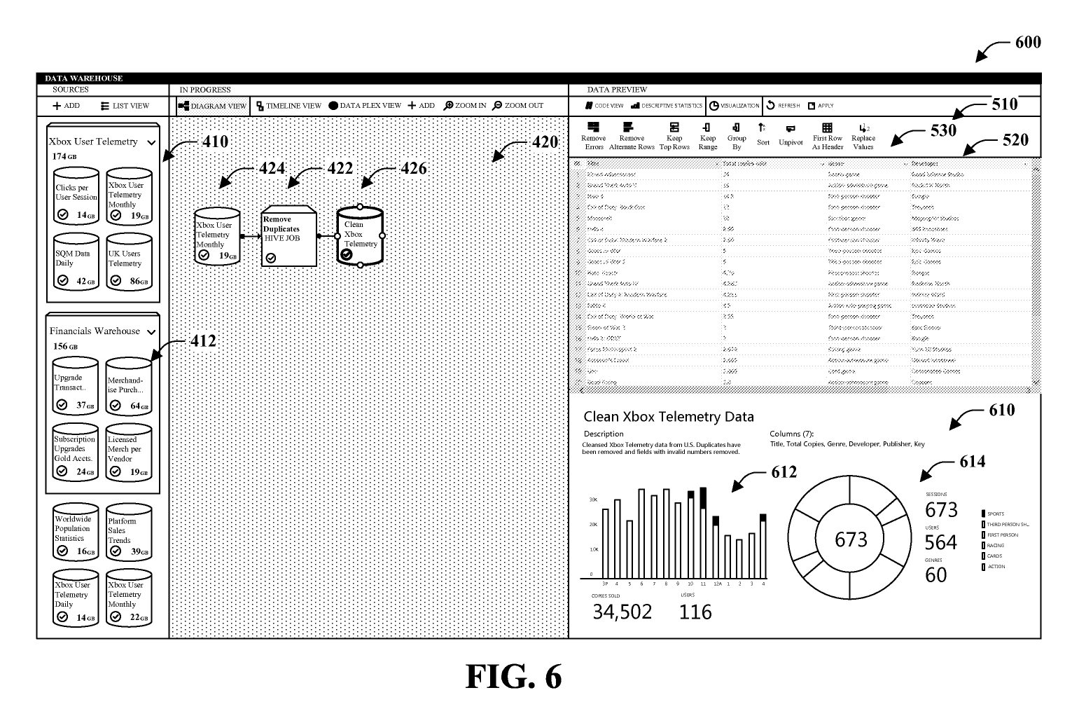

FIG. 6 is a screenshot of a visual authoring interface 600 that can be produced by the visual authoring system 100. Similar to interface 500 of FIG. 5, the interface 600 includes the source panel 410, the workspace panel 420 with a representation of a data source highlighted to indicate selection, and the preview panel 510 comprising the first portion 520 displaying at least a subset of data from the selected data source and the second portion 530 presenting representations of a set of transformation operations. Here, in a third portion 610 graphical visualizations are presented regarding the data source. In accordance with one aspect, this interface can be displayed upon selection of a particular tab provided in the preview panel 510. Data employed to generate the visualizations can be acquired from the data source itself, including metadata associated therewith, as well as determined statistic measures, among other sources. Here, histogram 612 provides a representation of the number of copies of a product, such as a video game, that were sold and the type or genre thereof. Ring graph 614 identifies a number of video game sessions broken down by the type or genre of the video game. These visualizations provide quick insight into the nature and distribution of data to complement actual data from the data source displayed in the first portion 520.

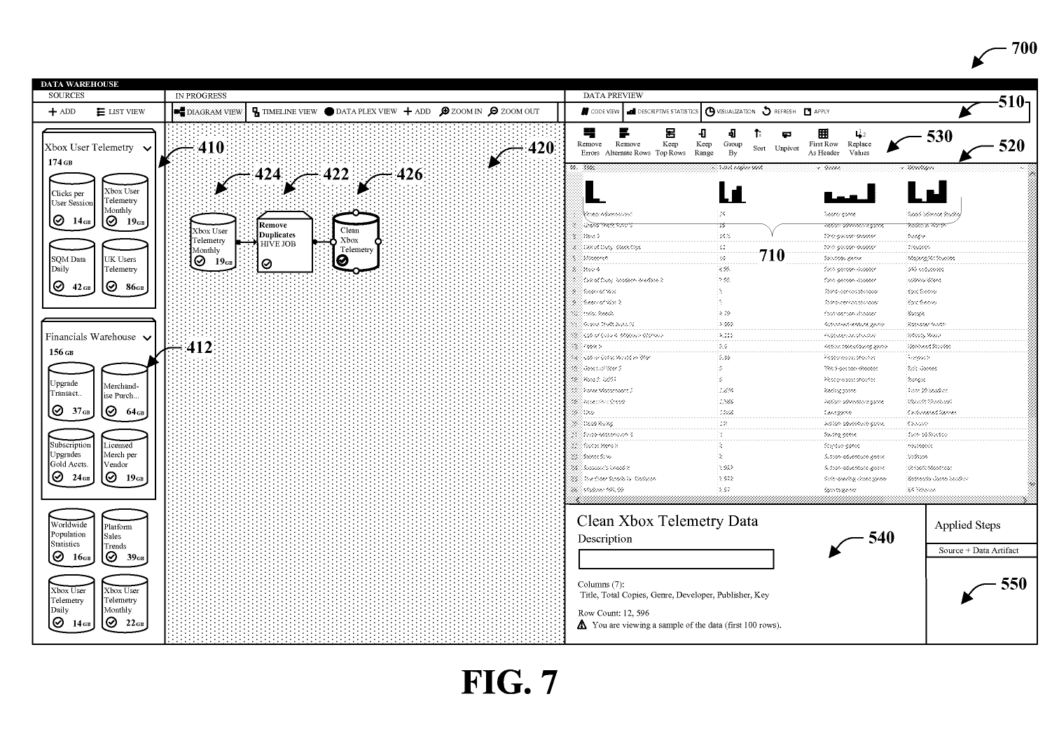

FIG. 7 is a screenshot of a visual authoring interface 700 that can be generated by visual authoring system 100. The interface 700, similar to interface 500 of FIG. 5, includes source panel 410, workspace panel 420 including the selected representation of a data source, the preview panel 510, and the first portion 520 representing at least a subset of data of the selected data source. Additionally, interface 700 includes bar graph visualizations 710 associated with each column of data. In one instance, statistical measures can be utilized to populate these graphs. Here, a row is generated for each column beginning with the column name and relevant statistics are computed for the column and graphically visualized. These visualizations enable users to gain insight quickly regarding the data in each column.

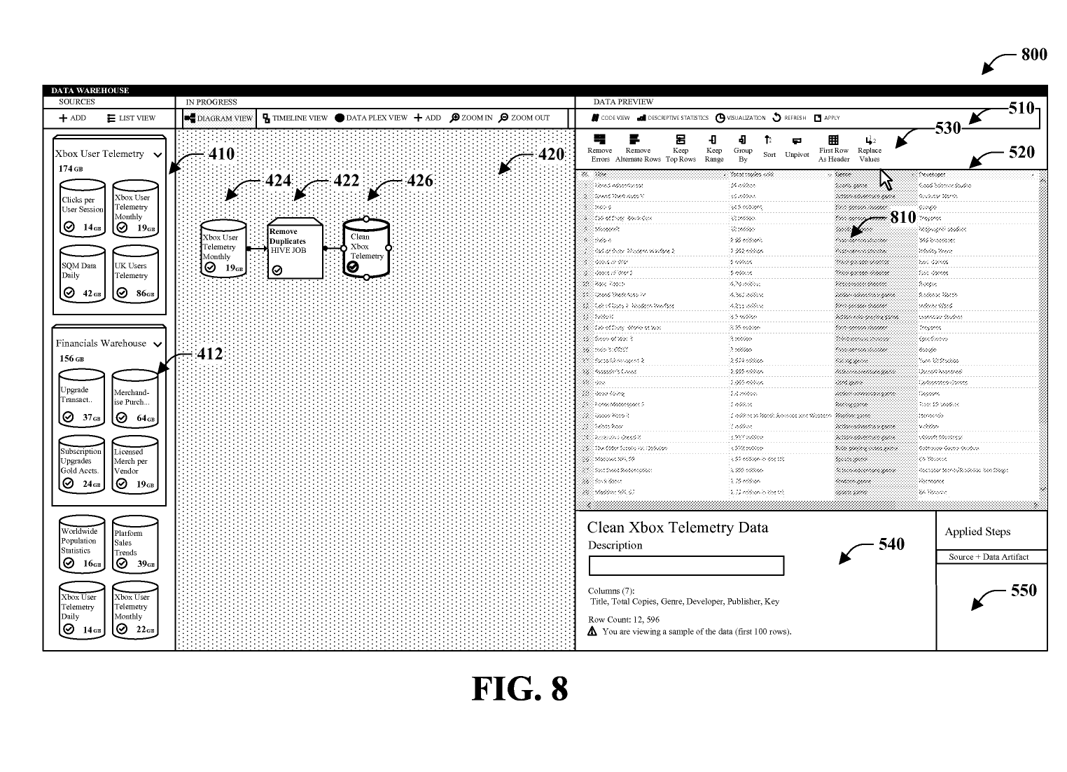

FIG. 8 is a screenshot depicting a visual authoring interface 800 that can be generated by the visual authoring system 100. Here, interface 800 is substantially the same as interface 500 of FIG. 5. In particular, the interface illustrates the source panel 410, the workspace panel 420, and the preview panel 510 associated with a selected data source in the workspace panel 420. In accordance with one aspect, transformation operations can be specified visually by selecting a representation of an operation from a tool bar in the second portion 530. Furthermore, operator parameters can be specified visually by selecting data presented in the first portion 520 of the preview panel 510. Reference numeral 810 indicates selection of a column of data to parameterize an operation. Consider a “group by” operation, for example. A “group by” operation typically requires a column name parameter. Upon selection of a representation of a “group by” operation from the second portion 530, a user can select the third column to parameterize the operation. Of course, other interactions can produce substantially the same result. For instance, the “group by” operation could be specified directly in code and a popup box could be presented to accept a parameter value.

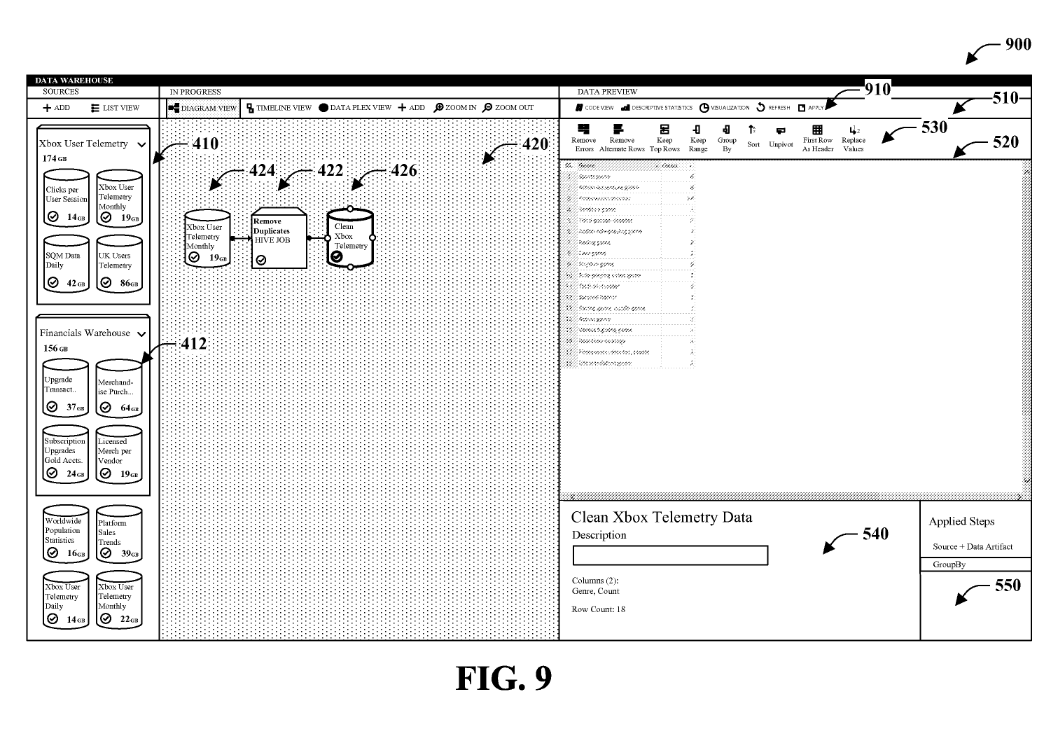

FIG. 9 illustrates a visual authoring interface 900 that results upon selection and parameterization of a transformation operation. In particular, interface 900 illustrates the results of graphical specification and parameterization of a “group by” operation, as previously described with respect to FIG. 8. As shown, the first portion 520 of the preview panel 510 is updated to include data grouped according parameters of the group operation, here genre. The forth portion 550 of the preview panel is also updated to reflect selection of the group by operation. The third component 540 can also change to display metadata reflective of the transformed data source. A user can select as many data transformation operations as needed to transform the data source into a desired form. Once done the changes can be applied, saved, or committed, for example by selecting a visual representation 910 associated with that function.

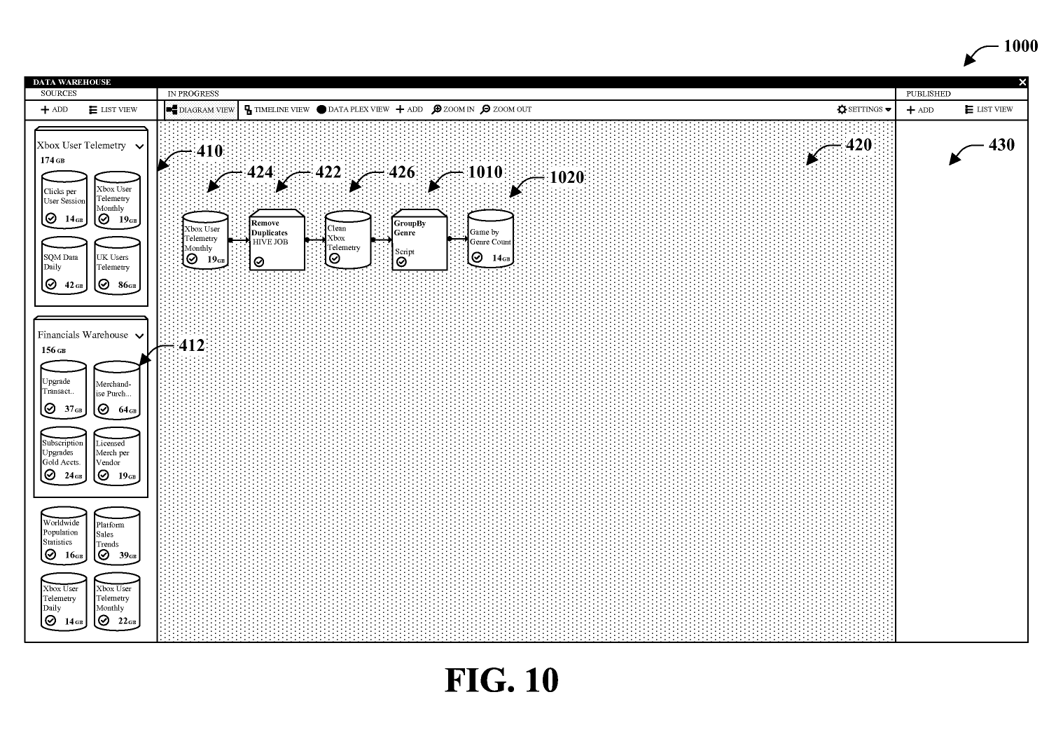

FIG. 10 is a screenshot of a visual authoring interface 1000 that can be displayed upon committing changes made. The visual authoring interface 1000 includes the source panel 410, the workspace panel 420, and the published panel 430, as previously described. The workspace panel 420 is updated to include the new job. Here, the new job, comprising one or more data transformation operations, is represented with second cube 1010 connected with an arrow from the source data structure represented by the second cylinder 426 to the second cube 1010. Additionally, the second cube 1010, representing a job, is connected with an arrow to third cylinder 1020 representing the new data source produced by the job.

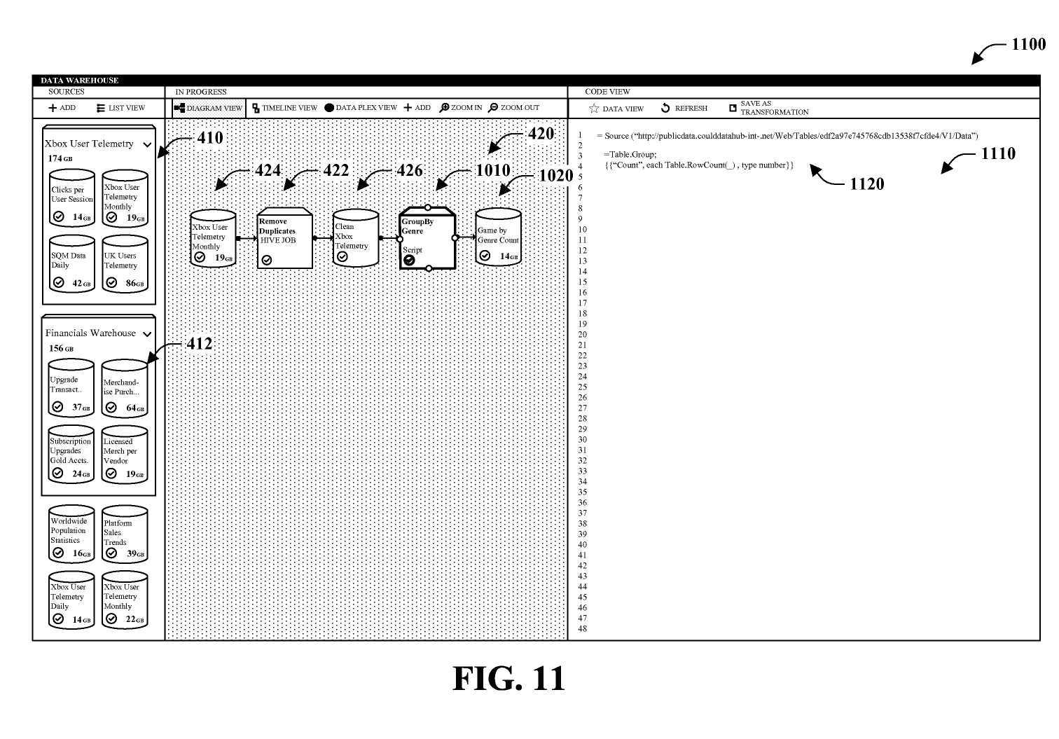

FIG. 11 is a screenshot of a visual authoring interface 1100 that results from selecting the job represented by the second cube 1010 with respect to visual authoring interface 1000 of FIG. 10. Similar to visual authoring interface 1000, visual authoring interface 800 includes a source panel comprising one or more representations of data sources and workspace panel 420 comprising a pipeline of jobs presented diagrammatically. The job represented by the second cube 1010 is highlighted to indicate selection. After selection, a code view panel 1110 is presented. The code view panel 1110 presents the computer-programming-language code 820 associated with the job comprising one or more transformation operations. Here, the code 1120 includes a “group by” operation in a text editor environment, wherein the operation was previously specified graphically within the preview panel 510. The code 1120 can be modified in line by adding, removing, or changing transformation operations. The modified code can then be saved and the job represented by second cube 1010 can be updated to include the changes. When authoring a job a user can manually code the job within the code view panel 1110 or specify it graphically within the preview panel 510. Further yet, a user can employ both manual code and graphical specification to author a job.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or employ of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example, and not limitation, context analyzer component 330 and the view generation component 320 can employ such mechanisms to determine or infer context information for use in query generation and an appropriate view based on the data, for instance.

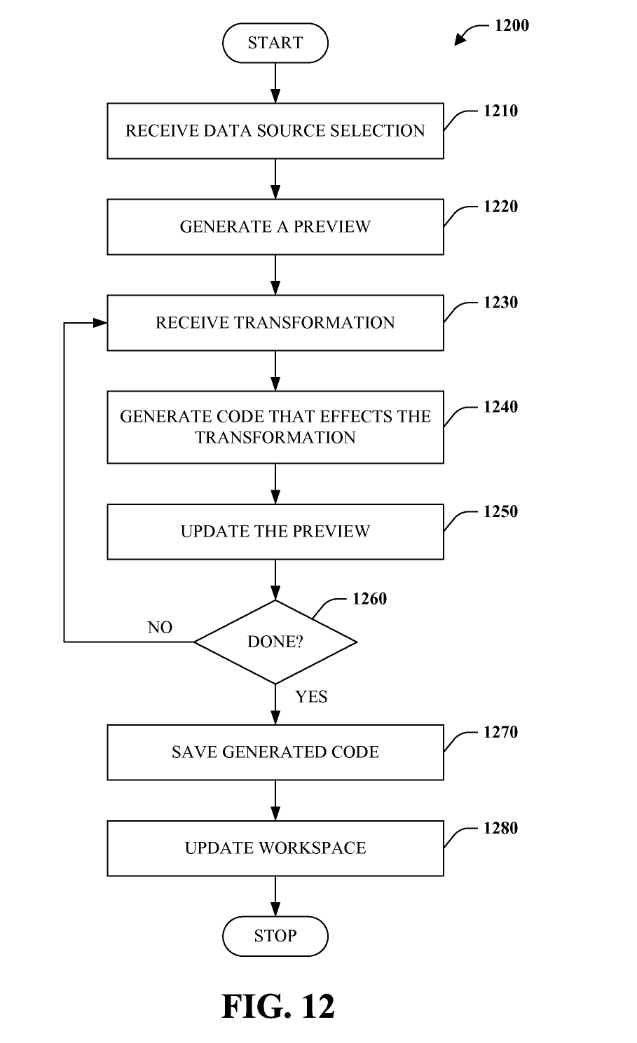

In view of the exemplary systems described above, methodologies that may be implemented in accordance with the disclosed subject matter will be better appreciated with reference to the flow charts of FIGS. 12-15. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 12, a method of assisting a user in authoring a job 1200 is illustrated. At reference numeral 1210, data is received from a selected data source. Although not limited thereto, a data source can be selected from those residing on a diagrammatic workspace. Further, the data can be received in response to processing a generated query over the selected data source.

At numeral 1220, a preview is generated based at least a subset of data source data. In accordance with one embodiment, the preview can be populated with the received data. For instance, the preview can display received data in a tabular form. In accordance with another embodiment, the preview can correspond to or include a graph (e.g., pie graph, bar graph, histogram . . . ), or other visualization (e.g., time line, map . . . ) generated with the received data. Further, users can select the form of a preview from available forms.

At numeral 1230, a transformation operation is received. The transformation operation can be received based on graphical selection and specification. The transformation operation can be received based on manual authoring of code or a combination of manual and graphical. Where the code was authored graphically, at numeral 1240, corresponding code is generated that effects the transformation operation. At numeral 1250, the preview is updated to reflect application of the transformation operation. At reference 1260, a determination is made as to whether or not authoring is done such that no more transformation operations will be received. If authoring is not done (“NO”), the method continues back at reference 1230 where another transformation operation is received. Alternatively, if authoring is done (“YES”), for example based on an explicit indication, the method continues to reference numeral 1270. At 1270, generated and manually authored code is saved. Next, at reference numeral 1280, the workspace is updated to include a job comprising one or more transformation operations. For instance, a representation of the input data source is connected to a representation of the job and the representation of the job is connected to the output data source.

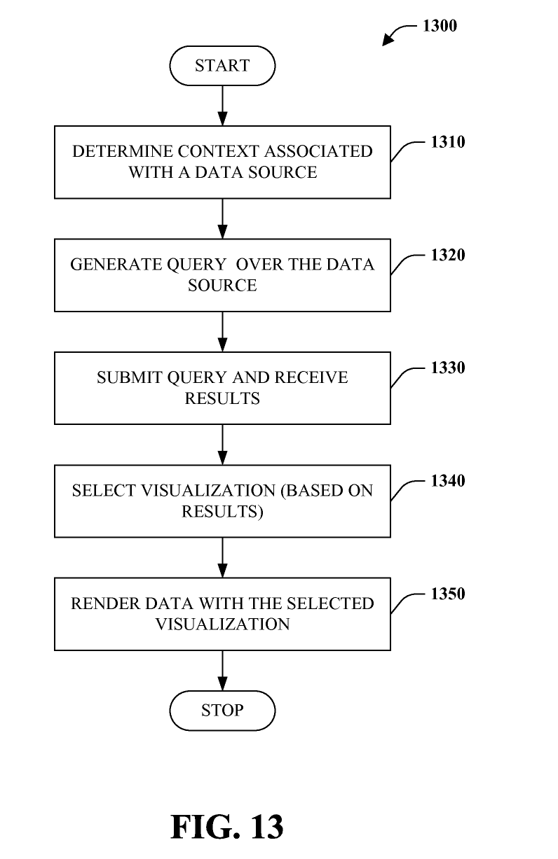

FIG. 13 depicts a method of generating a data preview 1300. At reference numeral 1310, context associated with the data source is determined. In particular, the nature of the data source is determined or inferred based on data source metadata, data source data, and/or prior interactions with the data source. For example, it would be helpful to know something about the size of the data source, including the number of rows or columns, as well as how users previously interacted with the data source. At numeral 1320, a query is generated over the data source. Query generation can take into account any determined context information. For example, by default the query generation can request the first hundred rows of data. However, the default can be overridden based on context information. For instance, for a large data source ordered alphabetically, it would be been to generate a query that randomly or pseudo-randomly samples the data or acquires the top fifty rows, the middle fifty rows, and the bottom fifty rows. Similarly, if is known or can be determined or inferred that the preview will be a graph it may be best to acquire additional information and/or perform sampling rather than return the first hundred rows. At numeral 1330, the query is submitted to a local or remote processor and results are received. At reference numeral 1340, the visualization for the preview is selected. For example, the visualization can by a table of data, a graph of the data, a timeline of data, or a map including the data, among others. Selection can be made based on user selection, preferences/settings, and/or the data. For example, data that includes longitude and latitude can be presented on a map while time dependent data can be displayed on a time line. At reference numeral 1350, the data is rendered with the selected visualization.

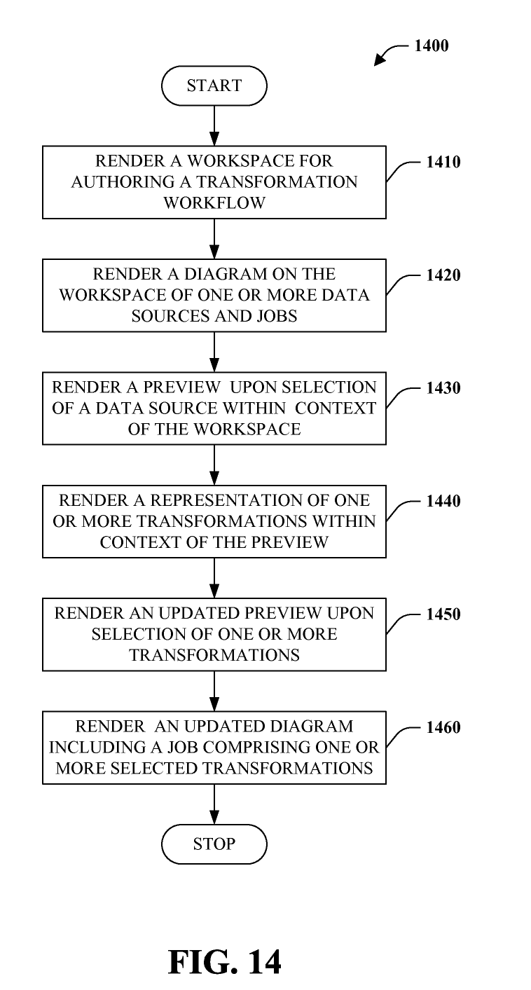

FIG. 14 is a flow chart diagram of a visualization method for job authoring 1400. At reference numeral 1410, a workspace is for authoring a transformation workflow is rendered. At numeral 1420, a diagram is rendered on the workspace comprising sources and jobs. At numeral 1430, the preview is rendered upon selection of a data source within the context of the workspace. In other words, the preview is render in-situ with the workspace rather than in a separate window outside the workspace. At reference numeral 1440, a representation of one or more transformation operations is rendered within the context of the preview. For example, the visualization can include a workspace pane and a preview pane, wherein preview pane includes a preview of a data source in a first portion and representations of transformation operations in a second portion. At numeral 1450, an updated preview is rendered upon selection of one or more transformation operations. For example, the preview can be updated to reflect selected operations. At numeral 1460, a workspace diagram is updated to include a job comprising one or more selected transformation operations.

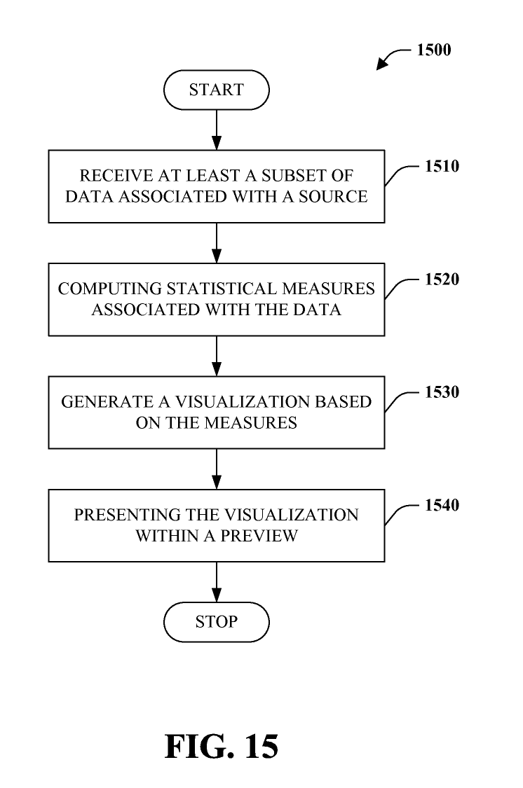

FIG. 15 is a flow chart diagram of a method of injecting a visualization into a preview 1500. At reference numeral 1510, at least a subset of data associated with a data source is received. For example, upon selection of a data source, data associated with the selected data source can be received. At numeral 1520, one or more statistical measures are computed over the received data. Examples of such statistical measures include but are not limited to counts (e.g., count of all rows, unique value count, missing value count), ranges (e g, minimum, maximum, range), and statistical summaries (e.g., mean, median, mode, variance, standard deviation . . . ), among others. At reference 1530, a visualization is generated based on at least one of the computed measures. In accordance with one embodiment, the visualization can correspond to a graph (e.g., bar, histogram, ring, pie . . . ). At reference numeral 1540, the visualization is presented within a preview. In one instance, the visualization can be incorporated within a representation of data. Additionally or alternatively, the visualization can be presented external to the data representation.

The subject disclosure supports various products and processes that perform, or are configured to perform, various actions regarding semi-automatic failover. What follows are one or more exemplary methods and systems.

In a computer configured to provide a graphical user interface on a display, a method comprising: presenting on the display in a first portion of the interface a representation of a data source on a workspace configured to enable diagrammatic job authoring; and presenting on the display in a second portion of the interface a data preview based on at least a subset of data acquired from the data source and one or more visual representations of transformation operations in response to selection of the data source. The method further comprises updating the data preview to reflect application of a transformation operation after selection of the transformation operation. The method further comprises presenting on the display in third portion of the interface a sequence of one or more selected transformation operations. The method further comprises presenting on the display in a third portion of the interface code that implements one or more selected transformation operations. The method further comprises automatically adding a visual representation of a job comprising one or more selected transformation operations to the workspace. The method further comprises presenting on the display in a second portion of the interface the data preview comprising a graph of the at least a subset of data. The method of further comprises presenting on the display in the second portion of the interface the data preview comprising two or more segments of data.

A method of facilitating job authoring comprises employing at least one processor configured to execute computer-executable instructions stored in memory to perform the following acts: generating a query over a data source for at least a subset of data in response to selection of a representation of the data source in a diagram of a visual workspace; and presenting a preview of the data source within context of the workspace based on query execution results. The method further comprises presenting visual representations of one or more data transformation operations within context of the preview. The method further comprises generating an updated query in response to selection of a transformation operation from the one or more data transformation operations, the updated query captures the selected transformation operation; and updating the preview based on updated query execution results. The method further comprises automatically adding a representation of a job to the workspace comprising the selected transformation operation. The method further comprises generating code configured to perform the selected transformation operation and visually presenting the code within context of the workspace. The method further comprises presenting the preview with a selected visualization.

A system that facilitates job authoring, comprising a processor coupled to a memory, the processor configured to execute the following computer-executable components stored in the memory: a first component configured to present a visual workspace for authoring jobs diagrammatically; and a second component configured to present a preview of a data source represented on the workspace concurrently with the workspace upon selection of the data source, the preview is generated from least a subset of data acquired from the data source based on results of execution of a generated query specifying the data. The system further comprises a third component configured to present a visual representation of one or more transformation operations in conjunction with the preview and a fourth component configured to update the preview to reflect application of one or more selected transformation operations. The system further comprises a third component configured to generate code associated with one or more selected transformation operations and to add a job comprising one or more selected transformation operations to the workspace. In one instance, the preview comprises two or more segments of the data from the data source. In another instance, the preview comprises a random or pseudorandom sampling of data from the data source. In still another instance, the preview comprises a graph of data from the data source.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

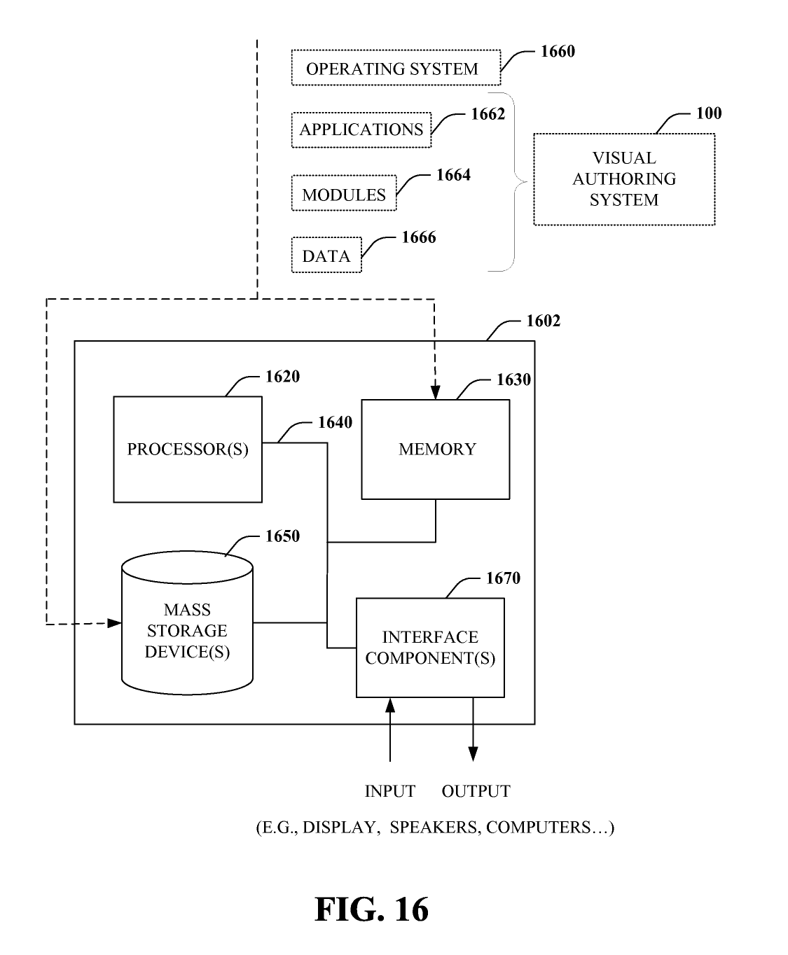

In order to provide a context for the claimed subject matter, FIG. 16 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory devices.

With reference to FIG. 16, illustrated is an example general-purpose computer or computing device 1602 (e.g., desktop, laptop, tablet, watch, server, hand-held, programmable consumer or industrial electronics, set-top box, game system, compute node . . . ). The computer 1602 includes one or more processor(s) 1620, memory 1630, system bus 1640, mass storage device(s) 1650, and one or more interface components 1670. The system bus 1640 communicatively couples at least the above system constituents. However, it is to be appreciated that in its simplest form the computer 1602 can include one or more processors 1620 coupled to memory 1630 that execute various computer executable actions, instructions, and or components stored in memory 1630.

The processor(s) 1620 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1620 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) can be a graphics processor.

The computer 1602 can include or otherwise interact with a variety of computer-readable media to facilitate control of the computer 1602 to implement one or more aspects of the claimed subject matter. The computer-readable media can be any available media that can be accessed by the computer 1602 and includes volatile and nonvolatile media, and removable and non-removable media. Computer-readable media can comprise two distinct types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that store, as opposed to transmit or communicate, the desired information accessible by the computer 1602. Accordingly, computer storage media excludes modulated data signals.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 1630 and mass storage device(s) 1650 are examples of computer-readable storage media. Depending on the exact configuration and type of computing device, memory 1630 may be volatile (e.g., RAM), non-volatile (e.g., ROM, flash memory . . . ) or some combination of the two. By way of example, the basic input/output system (BIOS), including basic routines to transfer information between elements within the computer 1602, such as during start-up, can be stored in nonvolatile memory, while volatile memory can act as external cache memory to facilitate processing by the processor(s) 1620, among other things.

Mass storage device(s) 1650 includes removable/non-removable, volatile/non-volatile computer storage media for storage of large amounts of data relative to the memory 1630. For example, mass storage device(s) 1650 includes, but is not limited to, one or more devices such as a magnetic or optical disk drive, floppy disk drive, flash memory, solid-state drive, or memory stick.

Memory 1630 and mass storage device(s) 1650 can include, or have stored therein, operating system 1660, one or more applications 1662, one or more program modules 1664, and data 1666. The operating system 1660 acts to control and allocate resources of the computer 1602. Applications 1662 include one or both of system and application software and can exploit management of resources by the operating system 1660 through program modules 1664 and data 1666 stored in memory 1630 and/or mass storage device (s) 1650 to perform one or more actions. Accordingly, applications 1662 can turn a general-purpose computer 1602 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, visual authoring system 100 or portions thereof, can be, or form part, of an application 1662, and include one or more modules 1664 and data 1666 stored in memory and/or mass storage device(s) 1650 whose functionality can be realized when executed by one or more processor(s) 1620.

In accordance with one particular embodiment, the processor(s) 1620 can correspond to a system on a chip (SOC) or like architecture including, or in other words integrating, both hardware and software on a single integrated circuit substrate. Here, the processor(s) 1620 can include one or more processors as well as memory at least similar to processor(s) 1620 and memory 1630, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the visual authoring system 100 and/or associated functionality can be embedded within hardware in a SOC architecture.

The computer 1602 also includes one or more interface components 1670 that are communicatively coupled to the system bus 1640 and facilitate interaction with the computer 1602. By way of example, the interface component 1670 can be a port (e.g., serial, parallel, PCMCIA, USB, FireWire . . . ) or an interface card (e.g., sound, video . . . ) or the like. In one example implementation, the interface component 1670 can be embodied as a user input/output interface to enable a user to enter commands and information into the computer 1602, for instance by way of one or more gestures or voice input, through one or more input devices (e.g., pointing device such as a mouse, trackball, stylus, touch pad, keyboard, microphone, joystick, game pad, satellite dish, scanner, camera, other computer . . . ). In another example implementation, the interface component 1670 can be embodied as an output peripheral interface to supply output to displays (e.g., LCD, LED, plasma . . . ), speakers, printers, and/or other computers, among other things. Still further yet, the interface component 1670 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. In a computer configured to provide a graphical user interface on a display, a method comprising:
presenting on the display in a first portion of the interface a representation of a data source on a workspace configured to enable diagrammatic job authoring; and
presenting on the display in a second portion of the interface a data preview based on at least a subset of data acquired from the data source and one or more visual representations of transformation operations in response to selection of the data source.

2. The method of claim 1 further comprises updating the data preview to reflect application of a transformation operation after selection of the transformation operation.

3. The method of claim 1 further comprises presenting on the display in third portion of the interface a sequence of one or more selected transformation operations.

4. The method of claim 1 further comprises presenting on the display in a third portion of the interface code that implements one or more selected transformation operations.

5. The method of claim 1 further comprises automatically adding a visual representation of a job comprising one or more selected transformation operations to the workspace.

6. The method of claim 1 further comprises presenting on the display in the second portion of the interface the data preview comprising two or more segments of data.

7. The method of claim 1 further comprises presenting on the display in the second portion of the interface a graph associated with the at least the subset of data.

8. A method of facilitating job authoring, comprising:
employing at least one processor configured to execute computer-executable instructions stored in a memory to perform the following acts:
generating a query over a data source for at least a subset of data in response to selection of a representation of the data source in a diagram of a visual workspace; and
presenting a preview of the data source within context of the workspace based on query execution results.

9. The method of claim 8 further comprises presenting visual representations of one or more data transformation operations within context of the preview.

10. The method of claim 9 further comprises:
generating an updated query in response to selection of a transformation operation from the one or more data transformation operations, the updated query captures the selected transformation operation; and
updating the preview based on updated query execution results.

11. The method of claim 10 further comprises automatically adding a representation of a job to the workspace comprising the selected transformation operation.

12. The method of claim 10 further comprising generating code configured to perform the selected transformation operation.

13. The method of claim 12 further comprises visually presenting the code within context of the workspace.

14. The method of claim 8 further comprises presenting the preview with a selected visualization.

15. A system that facilitates job authoring, comprising:
a processor coupled to a memory, the processor configured to execute the following computer-executable components stored in the memory:
a first component configured to present a visual workspace for authoring jobs diagrammatically; and
a second component configured to present a preview of a data source represented on the workspace concurrently with the workspace upon selection of the data source, the preview is generated from least a subset of data acquired from the data source based on results of execution of a generated query specifying the data.

16. The system of claim 15 further comprises a third component configured to present a visual representation of one or more transformation operations in conjunction with the preview.

17. The system of claim 16 further comprises a fourth component configured to update the preview to reflect application of one or more selected transformation operations.

18. The system of claim 16 further comprises a third component configured to generate code associated with one or more selected transformation operations.

19. The system of claim 16 further comprising a third component configured to add a job comprising one or more selected transformation operations to the workspace.

20. The system of claim 16, the preview comprises a random or pseudorandom sampling of data from the data source.
